(19) United States
(12) Patent Application Publication
(10) Pub. No.: US 2026/0358594 A1
(43) Pub. Date: Nov. 12, 2026

(54) CAMERA MODULE, AND VEHICLE COMPRISING SAME

(71) Applicant: LG INNOTEK CO., LTD., Seoul (KR)

(72) Inventors: Sung Jin PARK, Seoul (KR); Seung Won SEOK, Seoul (KR); Jun Young LIM, Seoul (KR)

(21) Appl. No.: 19/111,877

(22) PCT Filed: Sep. 11, 2023
(86) PCT No.: PCT/KR2023/013565

§ 371 Date: Mar. 14, 2025

(30) Foreign Application Priority Data
Sep. 14, 2022 (KR) 10-2022-0115833

(51) Int. Cl. G02B 7/02

(52) U.S. Cl. CPC G02B 7/028; G02B 7/021

(57) ABSTRACT

A camera module disclosed in an embodiment of the invention includes a plurality of lenses aligned along an optical axis; a lens barrel in which the plurality of lenses is disposed; and a plurality of inner barrels disposed between the plurality of lenses and the lens barrel, wherein at least one of the plurality of inner barrels may maintain an interval between two adjacent lenses and an interval between the outer surfaces of the two adjacent lenses and the lens barrel.

### TECHNICAL FIELD

An embodiment of the invention relates to a camera module and a vehicle having the same.

### BACKGROUND ART

ADAS (Advanced Driving Assistance System) is an advanced driver assistance system for assisting the driver to drive and is composed of sensing the situation in front, determining the situation based on the sensed result, and controlling the behavior of the vehicle based on the situation determination. For example, the ADAS sensor device detects a vehicle ahead and recognizes a lane. Then, when the target lane or target speed and the target in front are determined, the vehicle's ESC (Electrical Stability Control), EMS (Engine Management System), MDPS (Motor Driven Power Steering), etc. are controlled. Typically, ADAS may be implemented as an automatic parking system, a low-speed city driving assistance system, a blind spot warning system, and the like.

Sensor devices for sensing the situation ahead in ADAS include GPS sensors, laser scanners, front radar, and Lidar, but the most representative one is the front camera for filming the front of the vehicle. Recently, research on detection systems that detect the surroundings of the vehicle for driver safety and convenience is accelerating. The vehicle detection systems are used for various purposes, such as detecting objects around the vehicle to prevent collisions with objects that the driver does not recognize, as well as performing automatic parking by detecting empty spaces, and provide the most essential data for automatic vehicle control. In such a detection system, a method using a radar signal and a method using a camera are commonly used.

Vehicle camera modules are built into front and rear surveillance cameras and black boxes in cars and are used to capture subjects in photos or videos. Since vehicle camera modules are exposed to the outside, photographing quality may deteriorate due to moisture and temperature. In particular, camera modules have a problem in that their optical characteristics change depending on the surrounding temperature and the material of the lens.

### DISCLOSURE

### Technical Problem

A camera module according to an embodiment of the invention may provide a camera module having an inner barrel in one side or an entire inner surface of the lens barrel. An embodiment of the invention may provide a camera module having a plurality of inner barrels around different lenses in the lens barrel. An embodiment of the invention may provide a camera module having a first inner barrel in contact with an outer surface of at least one lens and a second inner barrel in contact with an outer surface of at least one lens in the lens barrel. An embodiment of the invention may provide a camera module having a plurality of inner barrels each disposed between an outer side of at least one or two or more lenses and the lens barrel.

An embodiment of the invention may provide a camera module having a plurality of inner barrels overlapped in the optical axis direction inside a lens barrel, and each of the plurality of inner barrels extending to an outer surface of at least one lens. An embodiment of the invention may provide a camera module in which a plurality of inner barrels has a material different from that of the lens barrel. An embodiment of the invention may provide a mobile terminal such as a mobile terminal and a vehicle having a camera module.

### Technical Solution

A camera module according to an embodiment of the invention includes a plurality of lenses aligned along an optical axis; a lens barrel in which the plurality of lenses is disposed; and a plurality of inner barrels disposed between the plurality of lenses and the lens barrel, wherein at least one of the plurality of inner barrels is disposed on an outer circumference between two adjacent lenses and a region between the outer surfaces of the two adjacent lenses and the lens barrel, and at least one of the plurality of inner barrels may maintain an interval between two adjacent lenses and an interval between the outer surfaces of the two adjacent lenses and the lens barrel.

According to an embodiment of the invention, each of the plurality of inner barrels may maintain the interval between two adjacent lenses and the interval between the outer surfaces of the two adjacent lenses and the lens barrel based on the outer surface of the lens barrel.

According to an embodiment of the invention, the plurality of lenses includes first to third lenses aligned along the optical axis from an object side toward a sensor, and the plurality of inner barrels may include a first inner barrel extending from an outer surface and a circumference of a sensor-side surface of the first lens to the outer surface and a circumference of an object-side surface of the second lens, and a second inner barrel extending from an outer surface and a circumference of a sensor-side surface of the second lens to an outer surface and a circumference of an object-side surface of the third lens.

According to an embodiment of the invention, the plurality of lenses includes a fourth lens to an n-th lens aligned with the optical axis on a sensor side of the third lens, where n is any one of 5, 6, and 7, and the plurality of inner barrel may include a third inner barrel extending from the outer surface and a circumference of a sensor-side surface of the third lens to an outer surface and a circumference of an object-side surface of the fifth lens. According to an embodiment of the invention, the third and fourth lenses are bonded in a cemented lens, and the third inner barrel is disposed between an object-side third lens of the cemented lens and the fifth lens disposed on a sensor side rather than the cemented lens, and an outer surface of the fourth lens may face the inner surface of the third inner barrel.

According to an embodiment of the invention, the plurality of inner barrels includes a fourth inner barrel extending from the outer surface and a circumference of the sensor-side surface of the fifth lens to an outer surface and circumference of an object-side surface of the sixth lens, and a fifth inner barrel extending from the outer surface and a circumference of sensor-side surface of the sixth lens to an outer surface and a circumference of the object-side surface of the seventh lens. According to an embodiment of the invention, a number of the plurality of inner barrels may be 50% or more of a number of the lenses. According to an embodiment of the invention, an image sensor disposed on a sensor side of the lens barrel; a cover glass disposed on the image sensor; and an optical filter disposed between the cover glass and a lens closest to the image sensor, and when the number of lenses is n (one of n=5, 6, or 7), a number of inner barrels may be n-2 or less.

According to an embodiment of the invention, a last inner barrel of the plurality of inner barrels is disposed between the n-th lens adjacent to the image sensor and an n-1 lens adjacent thereto, and may be extended to outer surfaces of the n-th lens and the n-1th lens. According to an embodiment of the invention, the plurality of inner barrels may have different heights.

According to an embodiment of the invention, the plurality of inner barrels has different heights, the plurality of inner barrels overlaps in a vertical direction, the plurality of inner barrels is made of plastic material, and at least one of the plurality of lenses is made of plastic material. According to an embodiment of the invention, the plurality of inner barrels has different heights, the plurality of inner barrels overlaps in the vertical direction, the lens barrel is made of a metal material, and the plurality of inner barrels are made of a plastic material, at least two lenses adjacent to the image sensor among the plurality of lenses may be made of plastic material. According to an embodiment of the invention, the height of each of the plurality of inner barrels may be smaller than a maximum optical axis distance between two lenses adjacent to the outer surface of the lens barrel and may be greater than a minimum optical axis distance the two lenses.

A vehicle according to an embodiment of the invention includes a camera module including a plurality of lenses aligned with an optical axis, a lens barrel having an opening penetrating in a direction of the optical axis, and a plurality of inner barrels disposed between each outer surface of the plurality of lenses and an inner surface of the lens barrel, and an image sensor disposed on a sensor side of a last lens of the plurality of lenses, wherein the camera module includes a camera module disclosed above, the plurality of inner barrels and at least two of the plurality of lenses are made of plastic material, and the plurality of inner barrels may overlap in a vertical direction.

### Advantageous Effects

According to an embodiment of the invention, it is possible to provide a camera module that may maintain resolution according to temperature changes by stacking lenses in heterogeneous barrels. That is, a camera module with a heterogeneous barrel may minimize stress and decentering of a lens, such as a plastic lens, that expands due to temperature changes. According to an embodiment of the invention, since the lens barrel includes a plurality of inner barrels therein, it is possible to provide a camera module that may maintain the resolution of the optical system and suppress deformation of the lenses due to temperature changes. According to an embodiment of the invention, the optical reliability of a camera module may be improved and the reliability of a vehicle camera device having a camera module may be improved.

### DESCRIPTION OF DRAWINGS

FIG. 1 is a side cross-sectional view of a camera module according to an embodiment of the invention.

FIG. 2 is a diagram showing the upper region of the lens barrel in the camera module of FIG. 1.

FIG. 3 is a diagram illustrating the lower region of the lens barrel of FIG. 1.

FIG. 4 is a cross-sectional view illustrating an example of coupling a cover on a lens barrel according to an embodiment of the invention.

FIG. 5 is an example of a vehicle having a camera module according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected” , “coupled” or “joined” to another component, the description may include not only being directly connected, coupled or joined to the other component but also being “connected” , “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Additionally, several embodiments described below can be combined with each other, unless specifically stated that they cannot be combined with each other. Additionally, unless specifically mentioned, parts omitted from the description of one of several embodiments may be applied to the description of other embodiments.

In the description of the invention, a first lens refers to the lens closest to the object side, and the last lens refers to the lens closest to the image side (or sensor surface). The last lens may include a lens adjacent to the image sensor. Unless otherwise specified in the description of the invention, the units for lens radius, thickness/distance, TTL, etc. are all mm. In this specification, the shape of the lens is expressed based on the optical axis of the lens. For example, saying that the object side of the lens is convex or concave means that the object side of the lens is convex or concave around the optical axis, but does not mean that the area around the optical axis is convex or concave. Therefore, even if the object side of the lens is described as convex, the portion around the optical axis on the object side of the lens may be concave or the opposite shape. In this specification, it should be noted that the thickness and radius of curvature of the lens are measured based on the optical axis of the lens. In other words, a convex lens surface means that the lens surface in the area corresponding to the optical axis has a convex shape, and a concave lens surface means that the lens surface in the area corresponding to the optical axis has a concave shape. can do. In addition, “object-side surface” may refer to the surface of the lens facing the object side based on the optical axis, and “sensor-side surface” may refer to the surface of the lens facing the sensor side based on the optical axis.

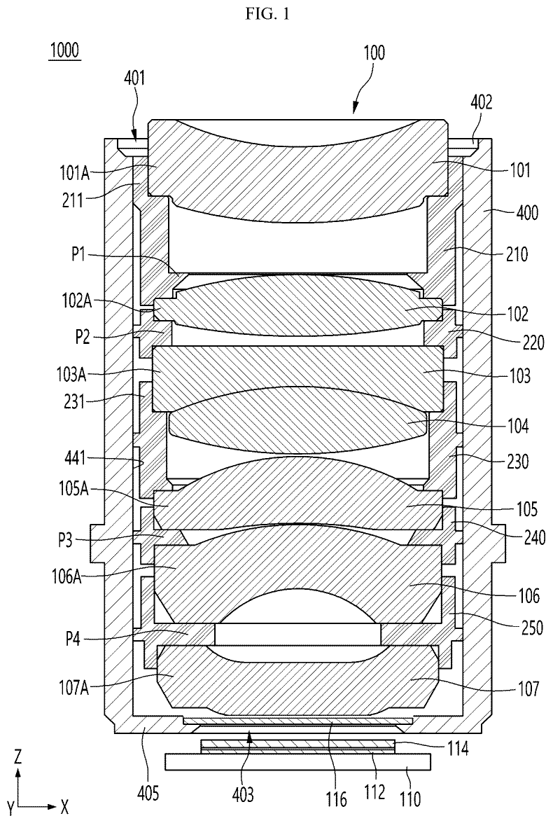

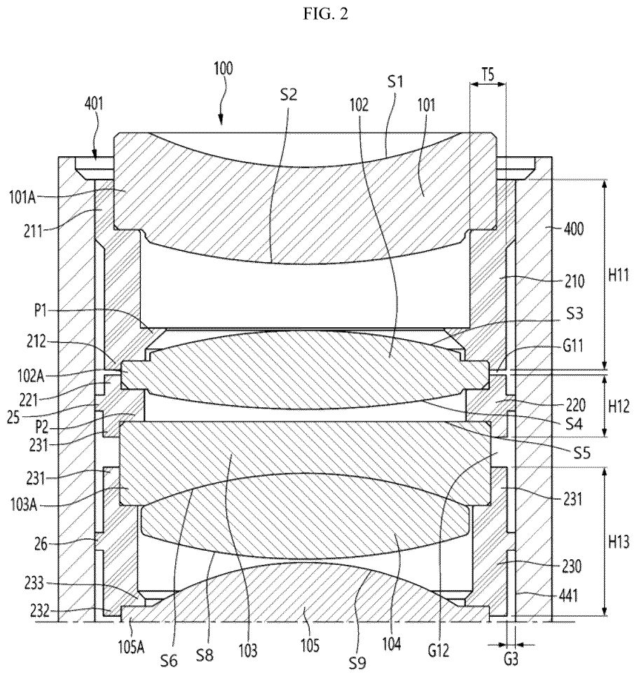

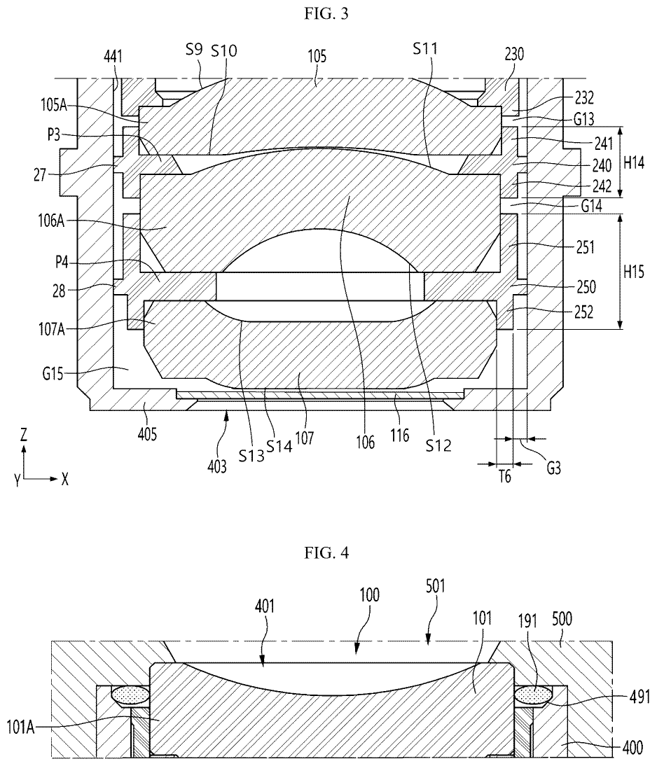

FIG. 1 is a side cross-sectional view of a camera module according to an embodiment of the invention, FIG. 2 is a view showing the upper region of the lens barrel in the camera module of FIG. 1, FIG. 3 is a view explaining the lower region of the lens barrel of FIG. 1, and FIG. 4 is a cross-sectional view illustrating an example of coupling a cover on a lens barrel according to an embodiment of the invention.

The camera module 1000 according to an embodiment of the invention includes a lens portion 100 having a plurality of lenses, a lens barrel 400 in which a plurality of lenses is stacked, and plurality of inner barrels 210, 220, 230, 240, and 250 disposed between the lens barrel 400 and the plurality of lenses.

The lens barrel 400 may be penetrated from an upper portion to a lower portion. That is, the lens barrel 400 has a first opening portion 401 on the upper side and a second opening portion 403 on the lower side, and the first opening portion 401 and the second opening portion 403 may be connected to each other. The lens barrel 400 is an outer barrel, and an interval between the outer surface of the lenses and the inner surface 441 of the lens barrel 400 may be 2.5 mm or less, for example, in a range of 0.7 mm to 2.5 mm. When the interval between the outer surface of the lenses and the inner surface 441 of the lens barrel 400 is smaller than the above range, it is not easy to combine the lenses, and when it is larger than the above range, the size of the lens barrel increases or the lens may be tilted with respect to the optical axis. Here, the lens barrel 400 may be made of metal or non-metallic material, for example, aluminum or copper. Accordingly, when the lens barrel 400 is made of a metal material, heat generated from the inner barrels 210, 220, 230, 240, and 250 and the flange portion of each lens may be dissipated, thereby preventing reliability of optical characteristics from being degraded due to a change in temperature of the camera module exposed to the outside.

The upper portion diameter of the inner opening portion of the lens barrel 400 may be larger than the lower portion diameter. Here, the upper portion diameter may be the maximum distance of the region corresponding to the outer surface of the flange portion 101A of the first lens 101. The lower portion diameter may be the maximum distance of the region corresponding to the outer surface of the flange portion 107A of the last lens 107. Lenses may be combined toward the sensor side through the object side due to the difference in the upper and lower portion diameters. In this case, the diameter of the first lens 101 may be larger than the diameter of the last seventh lens 107. The diameter of the two lenses is the maximum diameter between the outer surfaces of the flange portions 101A and 107A of each lens 101 and 107.

The lens barrel 400 may include a plurality of inner barrels 210-250 therein. The number of inner barrels 210-250 may be smaller than the number of lenses in the lens barrel 400, for example, in a range from n-1 to n-3, where n is the number of lenses and ranges from 4 to 9. Here, at least one of the upper portion, center portion, and lower portion of the inner barrel 210-250 may be disposed on the outer surface of at least one lens. That is, at least one of the upper, center, and lower portions of the inner barrels 210-250 may be disposed between the outer surface of at least one lens and the lens barrel. Accordingly, the outer surfaces of the lens barrel 400 and the lenses may be spaced apart from each other.

The thermal expansion coefficient of the inner barrel 210-250 may be made of a material that is higher than that of the lens barrel 400. For example, the lens barrel 400 may be made of a metal, such as aluminum, and the inner barrels 210-250 may be made of a non-metal, such as resin or plastic. The lens barrel 400 may have a thermal expansion coefficient of less than 30, and the inner barrel may have a thermal expansion coefficient of 50 or more. The difference in thermal expansion coefficient between the inner barrel 210-250 and the lens barrel 400 may be 20 or more. The difference in thermal expansion coefficient of the inner barrel 210-250 from the plastic lens may be 3 or less, 2 or less, or the same.

When the lens barrel 400 is injection molded from a metal material, there is a problem in that dimension control is difficult and diameter deviation occurs depending on the inner region. In other words, the decenter management between the inner diameter dimension and the inner diameter for alignment of the lenses is inferior than that of the mold injection products.

Additionally, most vehicle lenses in the lens barrel are made of glass. In the case of glass material, dimensional deviations exist due to the processing of each individual product, and in addition, the outer diameter size and decenter management between the outer diameters for lens alignment may be inferior than those of injection molded products, and the manufacturing cost of the lens is higher than that of the injection product. The invention manufactures the inner barrels 210-250 with a mold injection product, so that the deviation between the inner and outer diameters may be minimized, and the tolerance of the glass lens or plastic lens may be reduced to minimize decenter and tilt according to the tolerance. Additionally, the inner barrel may maintain resolution according to temperature changes. In other words, stress on the plastic lens may be suppressed and decentering may be minimized according to temperature changes. The inner barrel 210-250 may include a material or particle for blocking or absorbing light on its surface or inside. The inner barrels 210-250 may be made of a non-reflective material or a light-absorbing material, thereby blocking interference caused by light reflection.

At least one of the upper, inner, and lower portions of each of the inner barrels 210-250 may be in contact with the object-side surface and the sensor-side surface of the flange portion of at least one lens. The inner barrels 210-250 may be made of the same material or different materials. The inner barrels 210-250 may be made of plastic. Each of the inner barrels 210-250 has a hole penetrating therein, and at least one lens may be coupled to the upper portion, inner side, or lower portion of the inner through hole. The distance between the inner surface and the outer surface of each of the inner barrels 210-250, that is, the thickness, may be smaller than the distance (i.e., the thickness) between the inner surface 441 and the outer surface of the lens barrel 400. Here, the distance or thickness between the inner surface and the outer surface may be the interval between the inner surface and the outer surface having a vertical plane in a region corresponding to the outer surface of the lens.

The camera module 1000 may include a substrate 110 and an image sensor 112. The image sensor 112 may be disposed on the substrate 110. The image sensor 112 may be disposed between the last lens of the lens portion 100 and the substrate 110.

The image sensor 112 may be mounted, seated, contacted, fixed, temporarily fixed, supported, or coupled to the surface of the substrate 110. According to another example, a groove or hole (not shown) capable of accommodating the image sensor 112 may be formed in the substrate 110. The embodiment is not limited to a specific form in which the image sensor 112 is disposed on the substrate 110. The substrate 110 may be a rigid PCB or FPCB. The image sensor 112 may be disposed on the optical axis of the lens portion 100 or on an axis perpendicular to the optical axis of the lens portion 100. In this case, a reflective member such as a prism may be disposed between the lens portion 100 and the image sensor 112. The image sensor 112 may perform a function of converting light passing through the lens portion 100 into image data. The image sensor 112 may be one of a charge coupled device (CCD), complementary metal-oxide semiconductor (CMOS), CPD, or CID. When there are multiple image sensors 112, one may be a color (RGB) sensor and the other may be a black-and-white sensor.

The camera module 1000 may include a cover glass 114 and an optical filter 116 disposed between the last lens of the lens portion 100 and the image sensor 112. The optical filter 116 may be disposed between the lens portion 100 and the image sensor 112. The optical filter 116 may filter light corresponding to a specific wavelength range for light passing through the lenses. The optical filter 116 may be an infrared (IR) blocking filter that blocks infrared rays or an ultraviolet (UV) blocking filter that blocks ultraviolet rays, but the embodiment is not limited thereto. The optical filter 116 may be disposed on the image sensor 112. The optical filter 116 is disposed in the second opening portion 403 of the lens barrel 400 to filter light of a specific wavelength traveling to the lower portion of the lens barrel 400. The cover glass 114 is disposed between the optical filter 116 and the image sensor 112, protects the upper portion of the image sensor 112, and prevents the reliability of the image sensor 112 from deteriorating.

The lens portion 100 may include an optical system in which three or more lenses are stacked, or an optical system in which five or more lenses are stacked. The lens portion 100 may include 3 to 9 lenses. The lens portion 100 may include a plurality of solid lenses. The lens portion 100 may include lenses made of different materials, for example, a plastic lens and a glass lens. For example, the lens portion 100 may include one or more plastic lenses and two or more sheets of glass. The ratio of the number of plastic lenses to the number of glass lenses may be 1:2 to 1:6. The number of lenses made of glass may be larger or smaller than the number of plastic lenses. Alternatively, the lenses of the lens portion 100 may be made of the same glass material or plastic material. The lenses in the lens portion 100 may include a spherical lens and an aspherical lens. Alternatively, the lenses within the lens portion 100 may include spherical lenses. Alternatively, the lenses within the lens portion 100 may include aspherical lenses. Here, the spherical lens is a lens in which the object-side surface and the sensor-side surface of the lens on the optical axis are spherical. The aspherical lens has an object-side surface and a sensor-side surface of the lens on the optical axis. The spherical lens may be made of glass. The aspherical lens may be made of plastic or glass mold.

In the lens portion 100 according to an embodiment of the invention, the number of lenses made of glass may be one or more than the number of lenses made of plastic. Here, the lens portion 100 may be laminated with plastic lenses or/and glass lens(s). The coefficient of linear thermal expansion (CTE) of the plastic material is more than 5 times higher than that of the glass material, and the change value of the refractive index as a function of temperature may be more than 10 times higher for the plastic material than for the glass material. However, since plastic lenses are easier to manufacture and more convenient to design than glass lenses, the demand for their use is increasing. Additionally, the glass mold material may provide an aspherical surface, which may improve thin lens thickness and optical properties. Embodiments of the invention may reduce the weight of the camera module by mixing more plastic lenses into the camera module 1000, provide a cheaper manufacturing cost, and suppress deterioration of optical properties due to temperature changes. Various types of plastic lenses may replace glass lenses, and polishing and processing of lens surfaces such as aspherical surfaces or free-form surfaces may be easy.

The lens having the maximum effective diameter within the camera module 1000 may be any one of the first to fourth lenses 101, 102, and 103 arranged from the object side. Preferably, the lens having the maximum effective diameter may be made of glass. The effective diameter may be the diameter of the effective region where effective light enters each lens. The effective diameter is the average of the effective diameter of the object-side surface of each lens and the effective diameter of the sensor-side surface. Each of the lenses may include an effective region and a non-effective region. The effective region is a region through which light incident on each of the lenses passes. That is, the effective region may be defined as an effective region or effective diameter in which the incident light is refracted to realize optical characteristics. The non-effective region may be arranged around the effective region and may be defined as a flange portion. The non-effective region may be a region where effective light does not enter the plurality of lenses. That is, the non-effective region may be a region unrelated to the optical characteristics. Additionally, an end of the non-effective region may be a region fixed to a structure accommodating the lens.

The lens barrel 400 penetrates from an upper portion to a lower portion, and a plurality of lenses is coupled therein. The plurality of lenses may be coupled through the first opening portion 401 of the lens barrel 400. The plurality of lenses may be sequentially stacked from the lens 107 closest to the sensor side to the lens 101 closest to the object side. As another example, the lenses may be coupled toward the object through an opening portion of the sensor side, or may be coupled in both directions. The lens closest to the object side may be the first lens 101, and the sensor side lens closest to the optical filter 116 or the image sensor 112 may be the n-th lens or the last lens 107, n may be an integer of 5 or more, for example, any one of 5, 6, 7, 8, and 9.

The lens barrel 400 may be spaced apart from the outer surfaces of the lenses 101-107. The inner barrels 210-250 may extend between the inner surface 441 of the lens barrel 440 and the outer surface of the lenses 101-107. Each of the inner barrels 210-250 may space the flange portions of two adjacent lenses, and may space the outer surfaces of the two lenses and the lens barrels at a predetermined interval. The number of inner barrels 210-250 may be smaller than the number of lenses, and may be n-2 or less, for example, n-1 or n-2. The number of inner barrels 210-250 may be 50% or more and less than 100% of the number of lenses. When two lenses bonded among the lenses are used as one cemented lens, the number of inner barrels may be n-1, and when there is no cemented lens, the number of inner barrels may be n-2. Here, n ranges from 4 to 9.

Each of the inner barrels 210-250 may maintain an interval between two adjacent lenses based on the outer surface of the lens barrel 400 and an interval between the outer surfaces of the two adjacent lenses and the inner surface of the lens barrel. Additionally, at least one of the inner barrels may be smaller than the optical axis distance of two adjacent lenses, that is, the optical axis distance from the center of the object-side surface of the object-side lens to the center of the sensor-side surface of the sensor-side lens. That is, the height of the inner barrel may be smaller than the maximum optical axis distance of the two lenses adjacent to the outer surface of the lens barrel. Additionally, the height of the inner barrel may be greater than the minimum optical axis distance of the two lenses adjacent to the outer surface of the lens barrel. As another example, when a cemented lens is provided, the height of the inner barrel may be smaller than the maximum optical axis distance from the center of the object-side surface of the cemented lens to the center of the lens sensor surface adjacent thereto. Accordingly, the height of the cemented lens may be smaller than the maximum optical axis distance of two or three lenses.

Hereinafter, for convenience of explanation, an example of a structure in which seven lenses are sequentially stacked in the lens barrel 400 starting from the sensor side will be described. The lens portion 100 may have a plurality of lenses aligned along the optical axis from the object side toward the image sensor 112, for example, a first lens 101, a second lens 102, a third lens 103, a fourth lens 104, the fifth lens 105, the sixth lens 106, and the seventh lens 107 may be aligned. The second lens 102 may be disposed between the first lens 101 and the third lens 103. The fourth lens 104 is disposed between the third lens 103 and the fifth lens 105, and the sixth lens 106 is disposed between the fifth lens 105 and the seventh lens 107. The lens portion 100 may include a cemented lens in which two adjacent lenses are bonded. The cemented lens may include bonded second and third lenses, bonded third and fourth lenses, or bonded fifth and sixth lenses. The bonded lenses have opposite refractive powers and may compensate for chromatic aberration. As another example, lenses spaced apart from each other may be arranged in the lens portion 100 without a cemented lens.

The first lens 101 may be made of glass or plastic. The first lens 101 may have positive (+) or negative (−) refractive power on the optical axis (OA). The first lens 101 may have negative (−) refractive power. The first lens 101 is disposed closest to the object among the lenses, and may have, for example, an object-side first surface S1 that is concave from the optical axis and a sensor-side second surface S2 that is convex. Since the object-side first surface of the first lens 101 has a concave shape on the optical axis, problems of contact with external structures or damage from external impacts may be prevented. Additionally, the first lens 101 may be made of glass. The first lens 101 may be provided in an injection molded shape made of glass, and the first surface S1 on the object side and the second surface S2 on the sensor side may be aspherical. As another example, the first lens 101 may have a convex first surface S1 and a concave second surface S2 at the optical axis, and the first lens 101 may have a convex object-side surface. The amount of incident light may be increased through this. Alternatively, the first lens 101 may have a concave shape on both sides of the optical axis. The first lens 101 made of glass may reduce changes in the center position and radius of curvature due to temperature changes depending on the surrounding environment, and protect the incident side surface of the optical system 1000. Additionally, the flange portion 101A of the first lens 101 may have a flat surface on the object side, and the flat surface may block foreign substances from entering from the outside. Since the first lens 101 is made of a mold material, adhesion to the cover 500 (see FIG. 4) may be improved. As shown in FIG. 4, a cover 500 is coupled to the upper circumference of the flange portion 101A of the first lens 101, and the cover 500 may be coupled to the upper circumference of the lens barrel 400. The cover 500 may be made of the same metal material as the lens barrel 400, such as aluminum.

The camera module 1000 according to the embodiment may include an aperture stop. The aperture stop may control the amount of light incident on the optical system 1000. The aperture stop may be placed at a set position. For example, the aperture stop may be disposed around the perimeter between the first lens 101 and the second lens 102. Any one of the object-side inner barrels 210, 220, and 230 may function as the aperture stop. Alternatively, a light-blocking material coated on the surface of any one of the object-side inner barrels 210, 220, and 230 may function as an aperture stop. Alternatively, the perimeter of the sensor-side surface of the first lens 101 or the object-side surface of the second lens 102 may be coated with a light-blocking material to function as an aperture stop to adjust the amount of light. The first inner barrel 210 is disposed around the circumference between the first lens 101 and the second lens 102, and may maintain an interval between the first and second lenses 101 and 102, and an interval between the first and second lenses 101 and 102 and the lens barrel 400. The first inner barrel 210 may have a ring shape.

The second lens 102 may have positive (+) or negative (−) refractive power on the optical axis (OA). The second lens 102 may have positive (+) refractive power. The second lens 102 may have both surfaces S3 and S4 convex at the optical axis. Alternatively, the second lens 102 may have a concave object-side third surface S3 and a convex sensor-side fourth surface S4 at the optical axis. Alternatively, the second lens 102 may have a meniscus shape that is convex toward the object or a shape that is concave on both sides. The second lens 102 may be made of plastic or glass, for example, glass. The object-side surface and the sensor-side surface of the second lens 102 may be spherical.

The third lens 103 may have positive (+) or negative (−) refractive power on the optical axis (OA). The third lens 103 may include an object-side fifth surface S5 that is flat or concave and a concave sensor-side sixth surface S6 on the optical axis. Alternatively, the third lens 103 may have a convex object-side surface and a convex sensor-side surface on the optical axis. Alternatively, the third lens 103 may have a meniscus shape that is convex toward the sensor or a shape that is convex on both sides. The third lens 103 may be made of plastic or glass, for example, glass. The object-side surface and the sensor-side surface of the third lens 103 may be spherical. The second inner barrel 220 is disposed on the periphery between the second lens 102 and the third lens 103, and may maintain an interval between the second and third lenses 102 and 103, and an interval between the second and third lenses 102 and 103 and the lens barrel 400. The second inner barrel 220 may have a ring shape.

The fourth lens 104 may have positive (+) or negative (−) refractive power on the optical axis (OA). For example, the fourth lens 104 may have a convex object-side seventh surface and a convex sensor-side eighth surface S8 on the optical axis. Alternatively, the fourth lens 104 may have a meniscus shape that is convex toward the sensor or a shape that is concave on both sides. The fourth lens 104 may be made of plastic or glass, for example, glass. The object-side surface and the sensor-side surface of the fourth lens 104 may be spherical. The third lens 103 and the fourth lens 104 may be bonded in a cemented lens. The sensor-side sixth surface S6 of the third lens 103 and the object-side surface of the fourth lens 104 may be bonded. The third and fourth lenses 103 and 104 may have opposite refractive powers. The combined refractive power of the third and fourth lenses 103 and 104 may have positive (+) or negative refractive power. The product of the refractive power of the object-side lens and the refractive power of the sensor-side lens of the cemented lens may be less than 0. The product of the focal length of the object-side lens and the focal length of the sensor-side lens of the cemented lens may be less than 0. Accordingly, the aberration characteristics of the optical system may be improved. When the refractive powers of the two lenses of a cemented lens are the same, there is a limit to improving aberrations. The diameter of the fourth lens 104 may be larger than the diameter of the third lens 103.

One of the first, second, and third lenses 101, 102, and 103 may have the largest diameter, and the diameter may gradually decrease from one of the first, second, and third lenses 101, 102, and 103 to the last lens. Accordingly, the interval between the outer surface of the second inner barrel 300 and the inner surface of the lens barrel 400 may gradually increase from the region corresponding to the outer surface of the lens with the larger diameter among the second, third, fourth, and fifth lenses toward the sensor side.

The fifth lens 105 may have positive (+) or negative (−) refractive power on the optical axis (OA). The fifth lens 105 may include plastic or glass. For example, the fifth lens 105 may have a convex object-side surface and a concave sensor-side surface on the optical axis. Alternatively, the fifth lens 105 may have a meniscus shape that is convex toward the sensor or a shape that is concave on both sides. The object-side surface and the sensor-side surface of the fifth lens 105 may be spherical or aspherical. The third inner barrel 230 is disposed on the periphery between the third lens 103 and the fifth lens 105, and may maintain an interval between the third and fifth lenses 103 and 105 and an interval the third to fifth lenses 103, 104, and 105 and the lens barrel 400. The third inner barrel 230 may have a ring shape.

The sixth lens 106 may have positive (+) or negative (−) refractive power on the optical axis (OA). The sixth lens 106 may include plastic or glass. The sixth lens 106 may have a convex object-side surface and a concave sensor-side surface on the optical axis. The sixth lens 106 may have a meniscus shape convex toward the object. Alternatively, the sixth lens 106 may have a meniscus shape that is convex from the optical axis toward the sensor or a shape that is concave on both sides. The object-side surface and the sensor-side surface of the sixth lens 106 may be aspherical. The fourth inner barrel 240 is disposed on the periphery between the fifth lens 105 and the sixth lens 106, and may maintain an interval between the fifth and sixth lenses 105 and 106, and an interval between the fifth and sixth lenses 105 and 106 and the lens barrel 400. The fourth inner barrel 240 may have a ring shape.

The seventh lens 107 may have positive (+) or negative (−) refractive power on the optical axis (OA). The seventh lens 107 may have negative refractive power. The seventh lens 107 may include plastic or glass. For example, the seventh lens 107 may be made of plastic. The seventh lens 107 may have a meniscus shape convex from the optical axis toward the object. Alternatively, the seventh lens 107 may have a meniscus shape that is convex from the optical axis (OA) toward the sensor, or may have a shape that is concave on both sides. The object-side surface and the sensor-side surface of the seventh lens 107 may be aspherical.

The seventh lens 107 may be a plastic lens closest to the image sensor 400. By arranging the plastic lens closest to the image sensor 112, optical performance may be improved by the lens surface having an aspherical surface, thereby improving aberration characteristics and controlling the effect on resolution. Additionally, by placing a plastic lens as the lens closest to the image sensor 112, it may be insensitive to assembly tolerances compared to a glass lens. In other words, being insensitive to assembly tolerances means that optical performance may not be significantly affected even if the assembly is assembled with a slight difference compared to the design. The fifth inner barrel 250 is disposed on the periphery between the sixth lens 106 and the seventh lens 107, and may maintain an interval between the sixth and seventh lenses 106 and 107, and an interval between the sixth and seventh lenses 106 and 107 and the lens barrel 400. The fifth inner barrel 250 may have a ring shape.

The first inner barrel 210 may be disposed between the first flange portion 101A of the first lens 101 and the second flange portion 102A of the second lens 102. The upper protrusion 211 of the first inner barrel 210 extends to a center of the outer surface of the first flange portion 101A of the first lens 101, and may be located lower than an upper end of the outer surface of the first flange portion 101A of the first lens 101. The upper protrusion 211 of the first inner barrel 210 may be exposed on the first opening portion 401. The lower protrusion 212 of the first inner barrel 210 extends to a center of the outer surface of the second flange portion 102A of the second lens 102 and may be located higher than the lower end of the outer surface of the second flange portion 102A. The outer surfaces of the upper protrusion 211 and the lower protrusion 212 of the first inner barrel 210 may be spaced apart from the inner surface 441 of the lens barrel 400 at a minimum interval, and the minimum interval is an interval that may flow when at least one of the first and second lenses 101 and 102 is expanded in the horizontal direction, and may be 0.1 mm or less, for example, in the range of 0.05 mm to 0.1 mm. When the lens barrel 400 is made of a metal material, the first inner barrel 210 is made of a plastic material, and at least one of the first and second lenses 101 and 102 is made of glass, the minimum interval may be a maximum interval capable of expansion when the lenses 101 and 102 are thermally expanded in a horizontal direction at a high temperature, that is, in a range of 85 degrees to 105 degrees. The horizontal direction may be perpendicular to the optical axis. This minimum interval has the effect of keeping the inner barrel and lens barrel apart so that they do not contact each other even if the plastic lens expands at high temperatures, or does not cause significant stress to the lens even if they do contact. Additionally, when the lens, inner barrel, etc. expand/contract at high/low temperatures, the shape of the inner barrel may be provided in a structure where the changing positions do not affect each other.

The inner protrusion P1 of the first inner barrel 210 may extend around the object-side surface of the second lens 102. The inner protrusion P1 may function as an aperture stop. It may be a first interval G3 between the outer surface of the first inner barrel 210 and the inner surface 441 of the lens barrel 400. When at least one of the first and second lenses 101 and 102 is expanded in the horizontal direction by the first interval G3, the outer surface of the first inner barrel 210 flows outward and is restored when contracted. The first interval G3 between the first inner barrel 210 and the lens barrel 400 may be larger than the minimum interval between the first inner barrel 210 and the lens barrel 400. The first interval G3 is greater than an interval at which at least one of the lower lenses may flow when expanded in the horizontal direction, and may be 0.5 mm or less, for example, in a range of 0.1 mm to 0.5 mm. When the first inner barrel 210 is made of a plastic material and at least one of the fifth to seventh lenses 105, 106, and 107 is made of a plastic material, the first interval G3 may be the maximum interval that is expandable when the lower lens is thermally expanded in the horizontal direction at a high temperature, that is, in the range of 85 degrees to 105 degrees. The first interval G1 may be 10% or more, for example, 10% to 50% of the thickness of the first inner barrel 210, that is, the distance between the inner and outer surfaces. When the first interval G3 is smaller than the above range, a problem may occur in which at least one of the lower lenses is tilted with respect to the optical axis due to temperature changes, and when it is larger than the above range, the support and fixing power of the lower lenses may be difficult.

The height H11 of the first inner barrel 210 may be greater than the center thickness of the first lens 101, and for example, may be greater than the optical axis distance from the object-side surface of the first lens 101 to the object-side surface of the second lens 102. The height H11 of the first inner barrel 210 may be smaller than the optical axis distance from the object-side surface of the first lens 101 to the sensor-side surface of the second lens 102. This first inner barrel 210 functions as a spacer to maintain the interval between the two adjacent lenses 101 and 102, and may also serve as a flow barrel that maintains a flow interval between the outer surfaces of the two adjacent lenses 101 and 102 and the lens barrel 400. Additionally, the first inner barrel 210 may transmit elastic repulsion force to enable restoration of the horizontal position according to expansion and contraction of two adjacent lenses.

The second inner barrel 220 may be disposed between the second flange portion 102A of the second lens 102 and the third flange portion 103A of the third lens 103. The upper protrusion 221 of the second inner barrel 220 extends to the center of the outer surface of the second flange portion 102A of the second lens 102, and may be located lower than an upper end of an outer surface of the second flange portion 102A of the second lens 102. The upper protrusion 221 of the second inner barrel 220 may face the lower protrusion 212 of the first inner barrel 210 in a vertical direction. Here, the upper protrusion 221 of the second inner barrel 220 and the lower protrusion 212 of the first inner barrel 210 facing the outer surface of the second lens 102 may be spaced apart at a predetermined interval G11, and the interval G11 is the minimum interval considering the vertical expansion of the inner barrels 210-250.

The lower protrusion 222 of the second inner barrel 220 extends to the center of the outer surface of the third flange portion 103A of the third lens 103 and may be located higher than the lower end of the outer surface of the third flange portion 103A. The outer surfaces of the upper protrusion 221 and the lower protrusion 222 of the second inner barrel 220 may be spaced apart from the inner surface 441 of the lens barrel 400 by the outer protrusion 25 at the first interval G3, and the protruding length of the outer protrusion 25 may be equal to or greater than the first interval G3 disclosed above. Accordingly, when the lens barrel 400 is made of a metal material, the second inner barrel 220 is made of a plastic material, and at least one of the second and third lenses 102 and 103 is made of glass, when the lenses 102 and 103 are expanded at a high temperature or contracted at a low temperature by the first interval G3, it may be an interval that may flow. The outer protrusion 25 may be spaced apart from the inner surface 441 of the lens barrel 400 at a minimum interval. The outer protrusion 25 may protrude from the outer surface corresponding to the region between the second and third flange portions 102A and 103A, and may not collide with the expansion direction of each lens. The vertical thickness of the outer protrusion 25 may be smaller than the vertical thickness of the inner portion P2 of the second inner barrel 220. Accordingly, elasticity may be provided to the upper and lower protrusions 221 and 222 of the second inner barrel 220.

The height H12 of the second inner barrel 220 may be greater than the center interval between the second lens 102 and the third lens 103, and for example, may be greater than an interval between the second flange portion 102A of the second lens 102 and the third flange portion 103A of the third lens 103. The height H12 of the second inner barrel 220 may be smaller than the optical axis distance from the object-side surface of the second lens 102 to the object-side surface of the third lens 103. This second inner barrel 220 functions as a spacer to maintain the interval between the two adjacent lenses 102 and 103, and may also serve as a flow barrel that maintains a flow interval between the outer surfaces of the two adjacent lenses 102 and 103 and the lens barrel 400. Additionally, the second inner barrel 220 may transmit elastic repulsion force to enable restoration of the horizontal position according to expansion and contraction of the two adjacent lenses 102 and 103.

The third inner barrel 230 may be disposed between the third flange portion 103A of the third lens 103 and the fifth flange portion 105A of the fifth lens 105. The upper protrusion 231 of the third inner barrel 230 extends to the center of the outer surface of the third flange portion 103A of the third lens 103, and may be located lower than an upper end of the outer surface of the third flange portion 103A of the third lens 103. The upper protrusion 231 of the third inner barrel 230 may face the lower protrusion 222 of the second inner barrel 220 in a vertical direction. Here, the upper protrusion 231 of the third inner barrel 230 and the lower protrusion 222 of the second inner barrel 220 facing the outer surface of the third lens 103 may be spaced apart at a predetermined interval G12, the interval G12 is an interval formed by the minimum length at which the upper and lower protrusions 222 and 231 protrude to support the outer surface of the third lens 103.

The lower protrusion 232 of the third inner barrel 230 extends to the center of the outer surface of the fifth flange portion 105A of the fifth lens 105 and may be located higher than the lower end of the outer surface of the fifth flange portion 105A. The outer surfaces of the upper protrusion 231 and the lower protrusion 232 of the third inner barrel 230 may be spaced apart from the inner surface 441 of the lens barrel 400 by the outer protrusion 26 at a first interval G3, and the protruding length of the outer protrusion 26 may be greater than or equal to the first interval G3 disclosed above. Accordingly, when the lens barrel 400 is made of a metal material, the third inner barrel 230 is made of a plastic material, and at least one of the third and fifth lenses 103 and 105 is made of glass or plastic, when the lenses 103 and 105 are expanded at a high temperature or contracted at a low temperature by the third interval, it may be an interval that may flow. The outer protrusion 26 may be spaced apart from the inner surface 441 of the lens barrel 400 at a minimum interval. The outer protrusion 26 may protrude from the outer surface corresponding to the region between the third and fifth flange portions 103A and 105A, and may not collide with the expansion direction of each lens. The vertical thickness of the outer protrusion 26 may be greater than the center interval between the fifth and sixth lenses 105 and 106, and may be smaller than the interval G12 between the second and third inner barrels 220 and 230. Accordingly, the upper and lower protrusions 231 and 232 of the third inner barrel 230 may provide elasticity based on the outer protrusion 26. The inner protrusion 233 of the third inner barrel 230 may extend to the outer circumference of the object-side surface of the fifth lens 105.

The height H13 of the third inner barrel 230 may be greater than the center distance between the third lens 103 and the fifth lens 105, and for example, may be greater than an optical axis distance from a center of the object-side surface of the fourth lens 104 to a center of the object-side surface of the fifth lens 105. The height H13 of the third inner barrel 230 may be smaller than the optical axis distance from the object-side surface of the third lens 103 to the object-side surface of the fifth lens 105. This third inner barrel 230 functions as a spacer to maintain the interval between the two adjacent lenses 103 and 105, and may also serve as a flow barrel that maintains a flow interval the outer surfaces of the two adjacent lenses 103 and 105 and the lens barrel 400. Additionally, the third inner barrel 230 may transmit elastic repulsion force to enable restoration of the horizontal position according to expansion and contraction of the two adjacent lenses 103 and 105.

The fourth inner barrel 240 may be disposed between the fifth flange portion 105A of the fifth lens 105 and the sixth flange portion 106A of the sixth lens 106. The upper protrusion 241 of the fourth inner barrel 240 extends to the center of the outer surface of the fifth flange portion 105A of the fifth lens 105, and may be located lower than an upper end of outer surface of the fifth flange portion 105A of the fifth lens 105. The upper protrusion 241 of the fourth inner barrel 240 may face the lower protrusion 232 of the third inner barrel 230 in a vertical direction. Here, the upper protrusion 241 of the fourth inner barrel 240 and the lower protrusion 232 of the third inner barrel 230 facing the outer surface of the fifth lens 105 may be spaced apart at a predetermined interval G13, and the interval G13 is the minimum interval considering the vertical expansion of the inner barrel 210-250 and the plastic lenses.

The lower protrusion 242 of the fourth inner barrel 240 extends to the center of the outer surface of the sixth flange portion 106A of the sixth lens 106 and may be located higher than the lower end of the outer surface of the sixth flange portion 106A. The outer surfaces of the upper protrusion 241 and the lower protrusion 242 of the fourth inner barrel 240 may be spaced apart from the inner surface 441 of the lens barrel 400 by the outer protrusion 27 at a first interval G3, and the protruding length of the outer protrusion 27 may be greater than or equal to the first interval G3 disclosed above. Accordingly, when the lens barrel 400 is made of a metal material, the fourth inner barrel 240 is made of a plastic material, and at least one of the fifth and sixth lenses 105 and 106 is made of a plastic material, when the lenses 105 and 106 are expanded at a high temperatures or contract at low temperatures by the first interval G3, it may be an interval that may flow. The outer protrusion 26 may be spaced apart from the inner surface 441 of the lens barrel 400 at a minimum interval. The outer protrusion 27 may protrude from the outer surface corresponding to the area between the fifth and sixth flange portions 105A and 106A, and may not collide with the expansion direction of each lens. The vertical thickness of the outer protrusion 27 may be smaller than the vertical thickness of the inner portion P3 of the fourth inner barrel 240. Accordingly, the upper and lower protrusions 241 and 242 of the fourth inner barrel 240 may provide elasticity at the upper and lower portions with respect to the outer protrusion 27.

The height H14 of the fourth inner barrel 240 may be greater than the center interval between the fifth lens 105 and the sixth lens 106, and for example, may be smaller than an optical axis distance from a center of the object-side surface of the fifth lens 105 to the center of the object-side surface of the sixth lens 106. This fourth inner barrel 240 functions as a spacer to maintain the interval between the two adjacent lenses 105 and 106, and may also serve as a flow barrel that maintains a flow interval between the outer surfaces of the two adjacent lenses 105 and 106 and the lens barrel 400. Additionally, the fourth inner barrel 240 may transmit elastic repulsion force to enable restoration of the horizontal position according to expansion and contraction of the two adjacent lenses 105 and 106.

The fifth inner barrel 250 may be disposed between the sixth flange portion 106A of the sixth lens 106 and the seventh flange portion 107A of the seventh lens 107. The upper protrusion 251 of the fifth inner barrel 250 extends to the center of the outer surface of the sixth flange portion 106A of the sixth lens 106, and may be located lower than the upper end of the outer surface of the sixth flange portion 106A of the sixth lens 106. The upper protrusion 251 of the fifth inner barrel 250 may face the lower protrusion 242 of the fourth inner barrel 240 in a vertical direction on the outer surface of the sixth lens 106. Here, the upper protrusion 251 of the fifth inner barrel 250 and the lower protrusion 242 of the fourth inner barrel 240 may be spaced apart by a predetermined interval G14, and the interval G14 is an interval formed by the minimum interval considering the vertical expansion of the inner barrels 210-250 and the plastic lenses.

The lower protrusion 252 of the fifth inner barrel 250 extends to the center of the outer surface of the seventh flange portion 107A of the seventh lens 107 and may be located higher than the lower end of the outer surface of the seventh flange portion 107A. The outer surfaces of the upper protrusion 251 and the lower protrusion 252 of the fifth inner barrel 250 may be spaced apart from the inner surface 441 of the lens barrel 400 by the outer protrusion 28 at the first interval G3, and the protruding length of the outer protrusion 28 may be greater than or equal to the first interval G3 disclosed above. Accordingly, when the lens barrel 400 is made of a metal material, the fifth inner barrel 250 is made of a plastic material, and at least one of the sixth and seventh lenses 105 and 106 is made of a plastic material, when the lenses 106 and 107 are expanded at a high temperatures or contract at low temperatures by the first interval G3, it may be an interval that may flow.

The outer protrusion 28 may be spaced apart from the inner surface 441 of the lens barrel 400 at a minimum interval. The outer protrusion 28 may protrude from the outer surface corresponding to the region between the sixth and seventh flange portions 106A and 107A, and may not collide with the expansion direction of each lens. The vertical thickness of the outer protrusion 28 may be smaller than the vertical thickness of the inner portion P4 of the fifth inner barrel 250. Accordingly, the upper and lower protrusions 251 and 252 of the fifth inner barrel 250 may provide elasticity at the upper portion and lower portion with respect to the outer protrusion 28.

The height H15 of the fifth inner barrel 250 may be greater than the center distance between the sixth lens 106 and the seventh lens 107, and may be smaller than an optical axis distance from a center of the object-side surface of the sixth lens 106 to the center of the object-side surface of the seventh lens 107. This fifth inner barrel 250 functions as a spacer to maintain the interval between the two adjacent lenses 106 and 107, and may also serve as a spacer to maintain the flow barrel that maintains a flow interval between the outer surfaces of the two adjacent lenses 106 and 107 and the lens barrel 400. Additionally, the fifth inner barrel 250 may transmit elastic repulsion force to enable restoration of the horizontal position according to expansion and contraction of the two adjacent lenses 106 and 107.

The effective diameters of the first, second, and third lenses 101, 102, and 103 may be larger than the effective diameters of the sixth and seventh lenses 106 and 107. The third interval between the outer surfaces of the fourth to fifth inner barrels 240 and 250 and the lens barrel 400 may be greater than a third interval between the outer surfaces of the first and second inner barrels 210 and 220 and the lens barrel 400. This third interval may be the same depending on the difference in effective diameters of the lenses or may become larger closer to the sensor.

At least one or all of the inner barrels 210-250 may be made of a different material from the lens barrel 400. The first to fifth inner barrels 210-250 may be made of the same plastic material. Alternatively, at least one of the inner barrels 210-250 may be made of a metal material, such as the lens barrel 400, and for example, one of the second, third, and fourth inner barrels may be made of a metal material or a glass material. This allows an inner barrel made of metal or glass to be disposed outside the glass lens. Additionally, the material of the first to fifth inner barrels 210-250 may include a light-blocking or light-absorbing material or particle on the surface or inside to block light interference.

When at least one of the lenses 101 to 107 expands or contracts in the horizontal direction according to a temperature change in the lens barrel 400, the inner barrels 210 to 250 are interlocked in the horizontal direction, thereby preventing a decrease in resolution due to a temperature change. It may also reduce stress on plastic lenses due to temperature changes and minimize decentering of the optical axis. Additionally, compared to a structure in which a glass lens is directly coupled to the lens barrel, the lens coupling tolerance may be reduced, thereby reducing decentering and tilt on the optical axis. Additionally, when a plastic lens is applied with an inner barrel made of plastic, it has the same coefficient of thermal expansion, which may reduce the impact on optical properties due to thermal expansion or contraction. Additionally, by placing the inner barrel between the lens barrel and the outer surface of the lenses, stress that occurs when the lens is in direct contact with the lens barrel may be reduced.

As shown in FIG. 4, it may include a cover 500 coupled to the upper portion of the lens barrel 400. The ring member 191 may be disposed around the periphery between the lens barrel 400 and the first lens. The ring member 191 may be made of an elastic material or a resin material such as silicone or epoxy. The upper inner side 491 of the lens barrel 400 may have a concave groove or a concave curved shape for coupling the ring member 191. As another example, the ring member 191 may be coupled between the lens barrel 400 and the cover. The ring member 191 may perform a waterproof and dustproof function inside and/or outside the lens barrel 400.

Here, when explaining the order of combining each of the above components, the seventh lens 107, the fifth inner barrel 250, the sixth lens 106, the fourth inner barrel 240, the fifth lens 105, and the third inner barrel 230 may be sequentially stacked in the lens barrel 400, and then a cemented lens having the third and fourth lenses 103 and 104 may be coupled on the third inner barrel 230. Here, the optical filter 116 may be coupled to the inner bottom of the lens barrel 400 before coupling the lens barrel 400, or may be coupled to the outer lower portion of the lens barrel 400. As another example, the seventh lens 107 to the third lens may be connected through the lower portion of the lens barrel 400. Thereafter, when the third lens 103 is combined, the second inner barrel 220 is stacked, the second lens 102 is stacked on the inside of the second inner barrel 220, and the first inner barrel 210 may be stacked around the outer circumference of the second lens 102, and then the first lens 101 may be coupled to each other.

When at least one of the lenses 101 to 107 expands or contracts in the horizontal direction according to a temperature change in the lens barrel 400, the inner barrels 210 to 250 are interlocked in the horizontal direction, thereby preventing a decrease in resolution due to a temperature change. It may also reduce stress on plastic lenses due to temperature changes and minimize decentering of the optical axis. Additionally, compared to a structure in which a glass lens is directly coupled to the lens barrel, the lens coupling tolerance may be reduced, thereby reducing decentering and tilt on the optical axis. Additionally, when a plastic lens is applied with an inner barrel made of plastic, it has the same coefficient of thermal expansion, which may reduce the impact on optical properties due to thermal expansion or contraction. Additionally, by placing the inner barrel between the lens barrel and the outer surface of the lenses, stress that occurs when the lens is in direct contact with the lens barrel may be reduced.

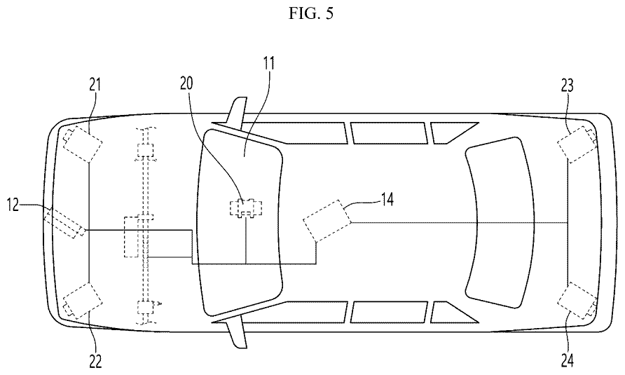

FIG. 5 is an example of a top view of a vehicle to which a camera module according to an embodiment of the invention is applied.

Referring to FIG. 5, the vehicle camera system according to an embodiment of the invention includes an image generating unit 11, a first information generating unit 12, second information generating units 21, 22, 23, 24, and a control unit 14. The image generating unit 11 may include at least one camera module 20 disposed in the own vehicle, and may generate a front image of the own vehicle or an image inside the vehicle by photographing the front and/or driver of the own vehicle. In addition, the image generating unit 11 may generate an image captured by the driver or the surroundings of the own vehicle in one or more directions as well as in front of the own vehicle by using the camera module 20. Here, the front image and the surrounding image may be a digital image, and may include a color image, a black-and-white image, and an infrared image. In addition, the front image and the surrounding image may include a still image and a moving image. The image generating unit 11 provides the driver image, the front image, and the surrounding image to the control unit 14. Next, the first information generating unit 12 may include at least one radar and/or a camera disposed on the own vehicle, and generates first detection information by detecting the front of the own vehicle. Specifically, the first information generating unit 12 is disposed in the own vehicle, and generates the first sensing information by detecting the positions and speeds of vehicles located in front of the own vehicle, the presence and location of pedestrians, and the like.

By using the first detection information generated by the first information generating unit 12, it is possible to control to maintain a constant distance between the own vehicle and the vehicle in front, and the stability of vehicle operation may be improved in a preset specific case, such as when the driver wants to change the driving lane of the own vehicle or when reverse parking. The first information generating unit 12 provides the first detection information to the control unit 14. The second information generating unit 21, 22, 23, 24 detect each side of the own vehicle and generate second sensing information based on the front image generated by the image generating unit 11 and the first sensing information generated by the first information generating unit 12. Specifically, the second information generating units 21, 22, 23, and 24 may include at least one radar and/or camera disposed on the own vehicle, and detect the positions and speeds of vehicles located on the side of the own vehicle, or may take a video. Here, the second information generating units 21, 22, 23, and 24 may be disposed on both sides of the front and rear of the own vehicle, respectively. Such the vehicle camera system may include the following camera module, and may protect the vehicle and objects from automatic driving or surrounding safety by providing or processing information obtained through the front, rear, each side or corner region of the own vehicle to the user.

At least one information generating unit of such a vehicle camera system may include the below-described camera module, and information obtained through the front, rear, each side or corner region of the vehicle may be provided or processed to the user to protect the vehicle and the object from automatic driving or ambient safety. An optical system of the camera module according to an embodiment of the invention may be mounted in a vehicle for safety regulation, reinforcement of autonomous driving functions, and increased convenience. In addition, the optical system of the camera module is a part for control such as a lane keeping assistance system (LKAS), a lane departure warning system (LDWS), and a driver monitoring system (DMS), and is applied in a vehicle. Such a vehicle camera module may realize stable optical performance even when ambient temperature changes and provide a module with competitive price, thereby securing reliability of vehicle components.

Features, structures, effects, etc. described in the above embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although described above, this is only an example and does not limit the present invention, and those with ordinary knowledge in the field to which this invention belongs will see that various modifications and applications not illustrated above are possible without departing from the essential characteristics of this embodiment. For example, each component specifically shown in the embodiment may be modified and implemented. In addition, the differences related to these modifications and applications should be construed as being included in the scope of the invention defined in the appended claims.

1. A camera module comprising:
a plurality of lenses aligned along an optical axis;
a lens barrel in which the plurality of lenses is disposed; and
a plurality of inner barrels respectively disposed between outer surfaces of the plurality of lenses and the lens barrel,
wherein at least one of the plurality of inner barrels is disposed on an outer circumference between two adjacent lenses and a region between outer surfaces of the two adjacent lenses and the lens barrel,
wherein at least one of the plurality of inner barrels maintains an interval between the two adjacent lenses and an interval between the outer surfaces of the two adjacent lenses and the lens barrel.

2. The camera module of claim 1,
wherein each of the plurality of inner barrels maintains the interval between two adjacent lenses and the interval between the outer surfaces of the two adjacent lenses and the lens barrel based on the outer surface of the lens barrel.

3. The camera module of claim 1,
wherein the plurality of lenses include first to third lenses aligned along the optical axis from an object side toward a sensor side,
wherein the plurality of inner barrels include: a first inner barrel extending from an outer surface and a circumference of a sensor-side surface of the first lens to an outer surface and a circumference of an object-side surface of the second lens, and a second inner barrel extending from the outer surface and a circumference of a sensor-side surface of the second lens to an outer surface and a circumference of an object-side surface of the third lens.

4. The camera module of claim 3,
wherein the plurality of lenses include n-th lenses aligned with the optical axis on a sensor side of the third lens, where n is any one of 5, 6, and 7,
wherein the plurality of inner barrels include a third inner barrel extending from the outer surface and a circumference of a sensor-side surface of the third lens to an outer surface and a circumference of an object-side surface of the fifth lens.

5. The camera module of claim 4,
wherein the third and fourth lenses are bonded in a cemented lens,
wherein the third inner barrel is disposed between an object-side third lens of the cemented lens and a fifth lens disposed on a sensor side rather than the cemented lens,
wherein an outer surface of the fourth lens faces an inner surface of the third inner barrel.

6. The camera module of claim 5,
wherein the plurality of inner barrels includes a fourth inner barrel extending from the outer surface and a circumference of a sensor-side surface of the fifth lens to an outer surface and circumference of an object-side surface of the sixth lens, and
wherein the plurality of inner barrels includes a fifth inner barrel extending from the outer surface and a circumference of a sensor-side surface of the sixth lens to an outer surface and a circumference of an object-side surface of the seventh lens.

7. The camera module of claim 1,
wherein a number of the plurality of inner barrels is 50% or more of a number of lenses,
wherein an inner barrel disposed outside a lens adjacent to an object side among the plurality of inner barrels functions as an aperture stop.

8. The camera module of claim 1, comprising:
an image sensor disposed on a sensor side of the lens barrel;
a cover glass disposed on the image sensor; and
an optical filter disposed between the cover glass and a lens closest to the image sensor,
wherein when a number of lenses is n (one of n=5, 6, or 7), a number of inner barrels is n-2 or less.

9. The camera module of claim 1,
wherein an inner barrel closest to an image sensor among the plurality of inner barrels is disposed between an n-th lens adjacent to the image sensor and an n-1th lens adjacent thereto, and extends to outer surfaces of the n-th lens and the n-1th lens.

10. The camera module of claim 1,
wherein the plurality of inner barrels have different heights,
wherein the plurality of inner barrels overlap in a vertical direction in which the lenses are stacked,
wherein the plurality of inner barrels are made of plastic material,
wherein at least one of the plurality of lenses is made of plastic material.

11. The camera module of claim 1,
wherein the plurality of inner barrels have different heights,
wherein the plurality of inner barrels overlap in a vertical direction,
wherein the lens barrel is made of metal material,
wherein the plurality of inner barrels are made of plastic material,
wherein at least two lenses adjacent to an image sensor among the plurality of lenses are made of plastic material.

12. The camera module of claim 1,
wherein a height of each of the plurality of inner barrels is smaller than a maximum optical axis distance between two lenses adjacent to an outer surface of the lens barrel,
wherein the height of each of the plurality of inner barrels is greater than a minimum optical axis distance between two lenses adjacent to the outer surface of the lens barrel.

13. A vehicle comprising:
a camera module including a plurality of lenses aligned with an optical axis, a lens barrel having an opening portion penetrating in a direction of the optical axis, a plurality of inner barrels disposed between each outer surface of the plurality of lenses and an inner surface of the lens barrel, and an image sensor disposed on a sensor side of a last lens of the plurality of lenses,
wherein the camera module includes a camera module according to claim 1,
wherein at least two lenses of the plurality of lenses and the plurality of inner barrels are made of plastic material, and
wherein the plurality of inner barrels overlap each other in a vertical direction.

14. The camera module of claim 1,
wherein the plurality of lenses include first to third object-side lenses,
wherein the plurality of inner barrels include a first inner barrel disposed between outer surfaces of the first and second lenses and the lens barrel, and a second inner barrel disposed between outer surfaces of the second and third lenses and the lens barrel,
wherein heights of the first and second inner barrels in a direction of the optical axis are different from each other.

15. The camera module of claim 14,
wherein the first inner barrel has an outer protrusion protruding toward the lens barrel and an inner protrusion protruding between the first and second lenses.

16. The camera module of claim 14,
wherein the second inner barrel has an outer protrusion protruding toward the lens barrel and an inner protrusion protruding between the first and second lenses.

17. The camera module of claim 1, comprising:
an optical filter disposed on a sensor side of a last lens of the plurality of lenses,
wherein the plurality of inner barrels include a sensor-side inner barrel disposed between the outer surfaces of two lenses adjacent to the optical filter and the lens barrel.

18. The camera module of claim 17,
wherein the sensor-side inner barrel includes an inner protrusion protruding around the two lenses adjacent to the optical filter and an outer protrusion protruding toward the lens barrel.

19. The camera module of claim 17,
wherein the lens barrel is made of a metal material,
wherein the plurality of inner barrels are made of a plastic material.

20. The camera module of claim 17,
wherein the plurality of lenses include a glass lens and a plastic lens,
wherein at least one of the plurality of inner barrels is disposed on outer surfaces of the glass lens and the plastic lens.
